(19) United States
(12) Patent Application Publication
(10) Pub. No.: US 2015/0071138 A1
(43) Pub. Date: Mar. 12, 2015

(54) Data Packet Generator With Isolation Link

(71) Applicant: WherePro, LLC, Minnetonka, MN (US)

(72) Inventors: Mark R. Daigle, Minnetonka, MN (US); Brian J. Holmes, St. Louis Park, MN (US); Joseph P. Tretter, III, Minneapolis, MN (US)

(73) Assignee: WHEREPRO, LLC, Minnetonka, MN (US)

(21) Appl. No.: 14/245,236

(22) Filed: Apr. 4, 2014

Related U.S. Application Data
(63) Continuation of application No. 13/025,517, filed on Feb. 11, 2011, now abandoned.
(60) Provisional application No. 61/303,533, filed on Feb. 11, 2010.

(51) Int. Cl. H04W 12/08; H04L 29/06; H04W 4/00; H04L 12/10; H04L 29/08

(52) U.S. Cl. CPC H04W 12/08; H04L 12/10; H04L 67/12; H04W 4/008; H04L 63/10
USPC 370/310

(57) ABSTRACT

A data packet generator device includes a processing device, a wireless communication device, and a network communication device. The processing device generates a token including alphanumeric characters. The wireless communication device receives the token from the processor and transmits the token as a network name. The network communication device also receives the token from the processing device and communicates the same token across a network communication cable.

### CROSS-REFERENCE TO RELATED APPLICATION

This application is a continuation of U.S. application Ser. No. 13/025,517, filed on Feb. 11, 2011, titled DATA PACKET GENERATOR WITH ISOLATION LINK; which claims priority to U.S. Provisional Application Ser. No. 61/303,533, titled DATA PACKET GENERATOR WITH ISOLATION LINK, filed on Feb. 11, 2010, the disclosures of which are hereby incorporated by reference in their entireties. To the extent appropriate, a claim of priority is made to each of the above-disclosed applications.

### BACKGROUND

Large organizations can benefit from ongoing portfolio planning services. However, the current practice for collecting occupancy data is a labor-intensive process that only captures a momentary, small sampling of utilization.

### SUMMARY

In general terms, this disclosure is directed to systems and methods that collect occupancy data without using sensors, bringing new value to IT departments in the process.

One aspect is a data packet generator device including a data packet generator and a separate pass-through adapter.

Another aspect is a data packet generator device including at least one processing device, a wireless communication device, and a network communication device. The at least one processing device generates a token including a plurality of alphanumeric characters. The wireless communication device is in data communication with the processing device and is operable to transmit the token as at least part of a network name. The network communication device is in data communication with the processing device and operable to communicate the token across a network communication cable.

Yet another aspect is a data packet generator including a data packet generator, a pass-through device, and an isolation link. The data packet generator includes a processing device programmed to generate a token. The pass-through device includes at least two network communication ports, and a communication hub. The communication hub includes electronics to pass network communications between the at least two network communication ports. The isolation link is configured to receive the token generated by the processing device and to communicate the token to the pass-through device.

A further aspect is an electronic device comprising a processing device, a wireless communication device, a network communication port, a power supply, and an isolation link. The processing device is operable to output a token. The wireless communication device includes an antenna that transmits radio-frequency signals encoding the token. The power supply is electrically connected to the network communication port to receive power from the network communication port to power the electronic device. The isolation link is interposed between the processing device and the network communication port.

### BRIEF DESCRIPTION OF THE DRAWINGS

FIG. 1 is schematic diagram of a portion of an example system for delivering real-time interior occupancy data including a data packet generator device.

FIG. 2 is a schematic block diagram illustrating another example of the data packet generator device shown in FIG. 1.

FIG. 3 is a schematic block diagram illustrating an architecture of an example computing device.

FIG. 4 is a perspective view of an example data packet generator device, illustrating the pass-through device separated from the housing and the data packet generator.

FIG. 5 is another perspective view of an example data packet generator device illustrating an infrared communication link.

FIG. 6 illustrates exemplary communications between a data packet generator device and a computing device.

FIG. 7 illustrates a data packet generator device connected to a worksurface.

FIG. 8 is a perspective view of an example data packet generator device.

FIG. 9 is a perspective view of an example data packet generator device connected to a worksurface.

FIG. 10 is another perspective view of an example data packet generator device connected to a worksurface.

FIG. 11 is a perspective view of a data packet generator device during a wireless transmission of a data packet.

FIG. 12 is a perspective view of another example data packet generator device including a data packet generator and two pass-through devices.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In one example embodiment, a system provides an automated and secure solution for delivering real-time interior occupancy data without sensors. By focusing on device location vs. occupant location, the system can be leveraged to provide new IT benefits including interior inventory tracking

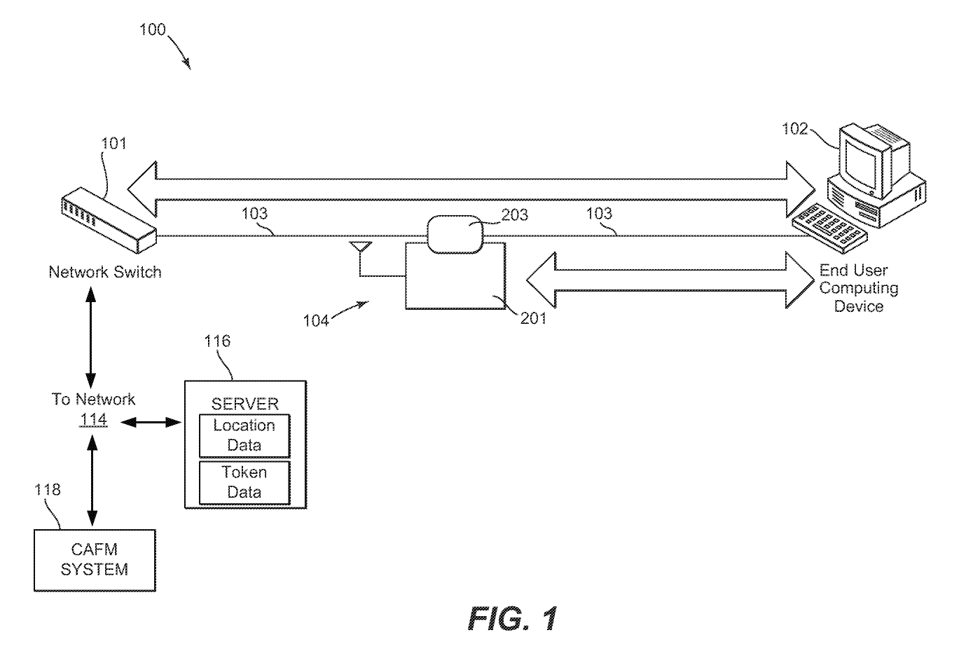

FIG. 1 is a schematic diagram of a portion of an example system 100. The system includes a data communication network 114 (including a network switch 101), a computing device 102, network cables 103, and data packet generator device 104.

Process

In one example, data packet generator devices 104 are installed in desired work areas. They may be fastened to a desk, wall, or other object within the workspace, for example. The location of each data packet generator device 104 is recorded within the Computer Aided Facilities Management (CAFM) system's 118 software application, such that each data packet generator device 104 is assigned to a particular location. A service running on administrator-controlled computing devices (PCs, laptops, smartphones, etc.) collects data packets from the data packet generator device 104 and delivers them across the network to the data packet generator server 116 for real-time authentication. This information is then linked to the CAFM system 118 drawing to provide real-time interior location information. The system can insert the username of the device to automate occupancy on the CAFM drawing.

Hardware

As shown in the example of FIG. 1, data packet generator device 104 includes, in some embodiments, at least two separate components: the data packet generator 201 and the pass-through device 203. Together, these two components provide a complete solution for IT networks that are wireless only, wired only, and mixed. In other words, the data packet generator device 104 can provide tokens wirelessly through the data packet generator 201 or through the network cables 103. Wireless communication can be useful for communicating with devices such as smart phones or laptops, for example, and wired communication can be useful for communicating with desktop personal computers or laptop computers that are plugged into a network cable.

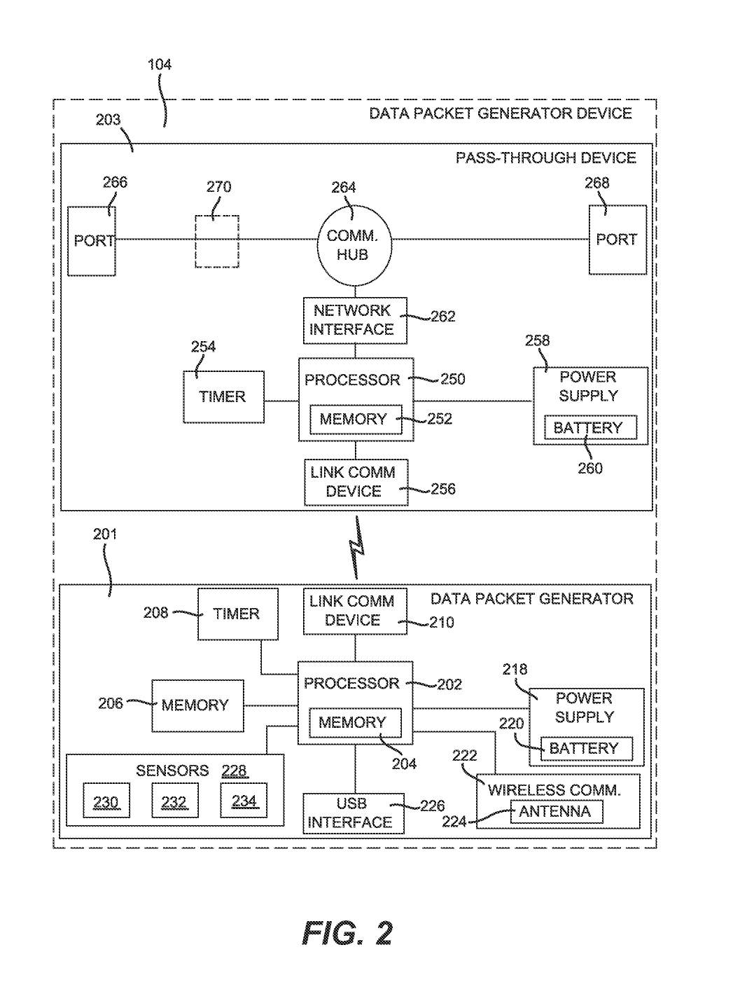

FIG. 2 is a schematic block diagram illustrating another example of the data packet generator device 104. In this example, data packet generator device 104 includes data packet generator 201 and pass-through device 203.

In some embodiments, the data packet generator 201 operates to generate data packets including a token comprised of a set of alphanumeric characters. Examples of data packet generators are described in more detail in U.S. Publication No. 2010/0046553 (U.S. Ser. No. 12/544,798), titled Data Packet Generator for Generating Passcodes. In some embodiments, the token includes between one and 32 digits. A data packet generator server 116 stores a copy of at least a portion of each of the tokens for the data packet generator, or stores an algorithm that can be used to determine at least a portion of each of the tokens for the data packet generator, to permit the server 116 to verify the token as a valid token. In some embodiments, the token changes periodically, such as once per minute, once per hour, once per day, etc.

In some embodiments, the data packet generator includes one output device. In other embodiments, the data packet generator contains two or more output devices. In some embodiments, the output devices are unidirectional output devices that are configured to send data, and do not receive data.

The first output device is a wireless communication device 222 (as shown in FIG. 2), such as an ultra low power Wi-Fi base station. Tokens can be transmitted by the wireless communication device through electromagnetic signals. In some embodiments, the tokens are transmitted in a service set identifier (SSID) according to an IEEE 802.11 protocol. In this example, the token is included in the SSID as a name of a locked wireless network. By inserting tokens into the network name, Wi-Fi enabled devices, such as a computer or a smartphone, can read this information without ever connecting to the locked network. Each data packet generator acts as a Wi-Fi base station and transmits its own data packets. Typically the broadcast range is short, such as 2-3 meters, although other possible embodiments utilize longer range communication.

The second output device is a link communication device 210 (shown in FIG. 2), such as an infrared (IR) output device. The same data packet transmitted by the wireless communication device 222 is also transmitted through this IR output device to the pass-through device 203. The link communication device 210 prevents any data from being communicated from the pass-through device 203 (and the network to which it is connected) to the data packet generator 201.

In some embodiments, the data packet generator 201 includes processor 202 (including memory 204), memory 206, timer 208, link communication device 210, power supply 218 (including battery 220), wireless communication device 222 (including antenna 224), USB interface 226, and sensors 228 (including sensors 230, 232, and 234).

Processor 202 is a physical component that operates to process data instructions. In addition to the other examples described herein, another example of processor 202 is an ultra low power Wi-Fi chip, such as the GS1010 or GS1011, manufactured by GainSpan Corporation located in Los Gatos, Calif., US.

Memory 204 and 206 is provided for storage of digital data. Examples of memory are discussed herein. In some embodiments, memory 204 and/or 206 contains data instructions, which when executed by the processor, cause the processor to implement one or more of the methods, modules, operations, or functions described herein. For example, in some embodiments the data instructions cause processor 202 to generate a data packet. The data packets are generated periodically in some embodiments, such as described herein. In some embodiments the data packet includes a serial number of data packet generator 201, one or more passcodes, or other data. Other examples of data that can be included in a data packet are described herein.

One or more timers 208 are included in some embodiments of data packet generator 201 to provide timing signals. In some embodiments there are two or more timers. A first timer provides timing systems for general operation of data packet generator 201. A second timer is used for a real-time clock. The real-time clock is used to keep the data packet generator 201 synchronized with other data packet generators, such as to identify a common wake up time.

Some embodiments of data packet generator 201 include a link communication device 210. The link communication device 210 allows data packet generator 201 to communicate data with pass-through device 203. In one example embodiment, the data communication is through infrared signals. In other possible embodiments, data communication is through other methods, such as magnetic induction or radio frequency signals. In one example, link communication device 210 is an infrared data association (IrDA) device operating, for example, at a 30 kHz frequency.

Power supply 218 provides power to data packet generator 104. In some embodiments power supply 218 includes one or more batteries 220. In some embodiments the battery 220 is small, such as sufficient to maintain data in memory 206, or to continue operating timer 208. In other embodiments, battery 220 is sufficient to fully power all of the components of data packet generator 201.

Power supply 218 includes electronics to provide power to data packet generator 104. Further, some embodiments of power supply 218 receive power from an external source. For example, some embodiments of data packet generator 104 include a power cord or power input port for receiving a power cord. In another possible embodiment, power is received at power supply 218 from network communication ports 266 or 268, such as from a Power over Ethernet system. Some embodiments include solar panels to convert light into electricity. Other embodiments receive power from other sources, such as from electromagnetic waves or electromagnetic induction.

In some embodiments, data packet generator 104 includes a wireless communication device 222 that permits data packet generator 104 to send and/or receive data wirelessly, such as through antenna 224. In some embodiments the wireless communication device 222 transmits data according to a data communication protocol. Examples of data communication protocols include the 802.11 family of wireless communication protocols, the Bluetooth protocol, and the Wireless Gigabit Alliance (WiGig) protocol.

Some embodiments include additional communication devices, such as a universal serial bus interface 226. USB interface 226 operates to communicate with a USB device according to one or more USB communication protocols. In some embodiments power supply 218 receives power through USB interface 226. In some embodiments, external devices are connected with the data packet generator 104 through USB interface 226. Examples of external devices include a USB memory stick, a camera, an external sensor, or a wide variety of other external devices. Other communication protocols are used in some embodiments. Some embodiments do not include additional communication devices. Further, some embodiments do not include any ports or interfaces for connection with another device, other than wireless communication device 222.

One or more sensors 228 are included in some embodiments, such as sensors 230, 232, and 234. Examples of sensors include tamper sensors (such as a screw presence sensor), position sensors (including GPS receivers, altitude sensors, distance from floor or ceiling sensors), movement sensors (such as an accelerometer), temperature sensors, user presence sensors (e.g., heat, motion, or sound sensors), smoke detector, asset tag sensor (such as an RFID receiver or 802.11 communication device), or other sensors. Some embodiments do not include sensors 228.

The pass-through device 203 connects two network communication ports where one port is connected to a computer (PC, laptop, etc), and the other port is connected to the network, such as a corporate local area network (LAN). The pass-through adapter sits between these two network communication ports, as shown in FIG. 1. An example of a network communication port is an Ethernet port.

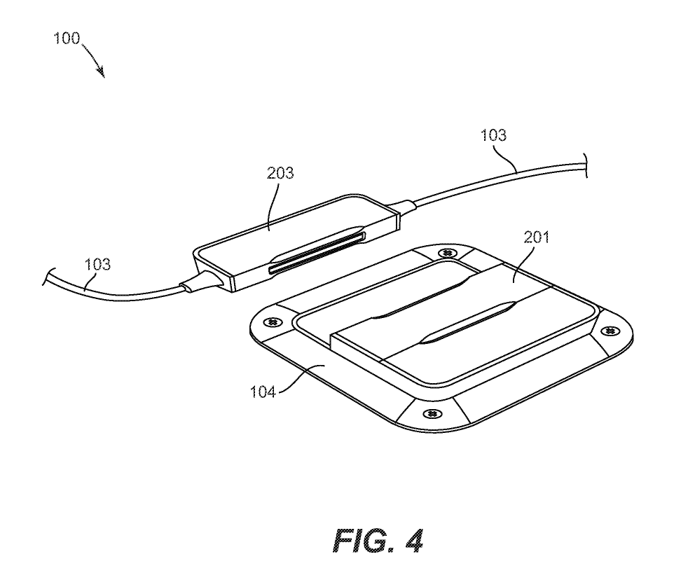

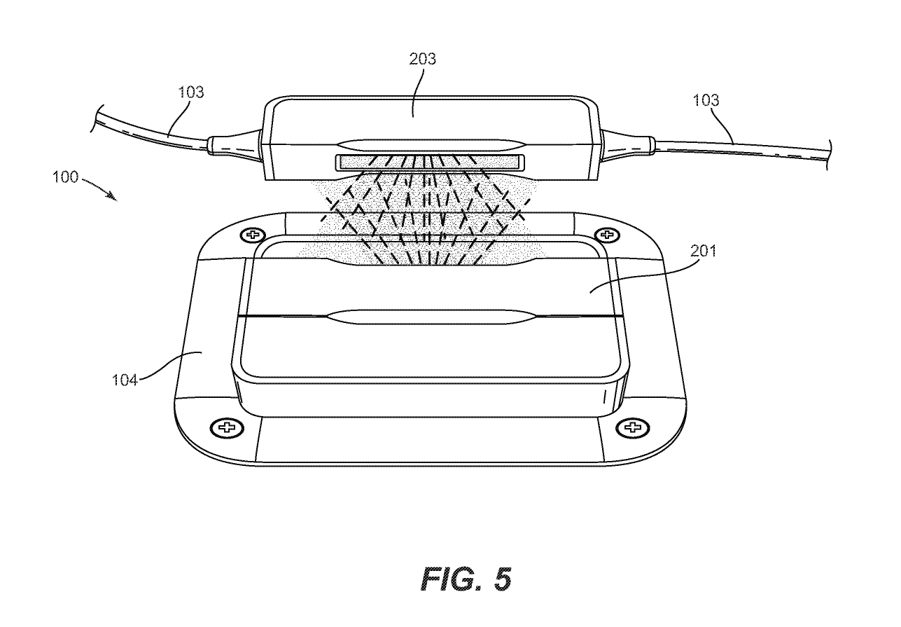

The pass-through device 203 communication resembles a network bridge or MAC Address filter. Normal LAN traffic flows unimpeded through the pass-through device while data packet generator 201 traffic only flows between the data packet generator and the end user's computing device 102. All communications take place automatically via a software service running on the end user's computing device (the pass-through device 203 does not initiate communications). The data packet generator 201 and pass-through device 203 are keyed for IR (or other wireless communication methods, such as magnetic inductance or radio-frequency communication). In some embodiments, the data packet generator 201 and the pass-through device 203 are connected to a housing, as illustrated in FIGS. 4-5.

In some embodiments, pass-through device 203 includes processor 250 (including memory 252), timer 254, link communication device 256, power supply 258 (including battery 260), network interface 262, communication hub 264, network port 266, and computer port 268. In some embodiments, power supply 258 and power supply 218 are a single power supply, and one or more conductors are used to supply power from the power supply between the pass-through device 203 and data packet generator 201.

Examples of processors and memory are discussed herein. In some embodiments, pass-through device 203 includes one or more timers 254, such as discussed herein.

Link communication device 256 and link communication device 210 collectively form an example of an isolation link. The link communication device 256 operates to communicate with link communication device 210. An example of a link communication device 256 is a photoreceptor that receives infrared signals from link communication device 256. In this example, processor 250 is used to remove the carrier signal (e.g., 30 kHz) to obtain the data therefrom. Other embodiments utilize other communication links, such as magnetic induction (e.g., through a magnetic inductance coil) or radio frequency (e.g., through a radio frequency receiver or transceiver).

Pass-through device 203 also includes a network communication system in some embodiments, such as including network interface 262, communication hub 226, and ports 266 and 268. In some embodiments, pass-through device 203, though connected to the network, does not communicate in the associated data communication network, other than to generate and transmit data packets as discussed in more detail herein, and to relay data packets between ports 266 and 268.

Network interface 262 provides a data communication interface between processor 250 and communication hub 264. An example of network interface 262 is an Ethernet interface device.

Communication hub 264 is a network hub that permits data communication between network port 266 (which can be connected to a network, such as the Ethernet, for receiving network communications), network interface 262, and computer port 268 (which can be connected to a computing device, such as a personal computer). An example of communication hub 264 is an Ethernet communication hub. Communication hub 264 is, in various embodiments, a passive hub, an active hub, or an intelligent hub. When data is received at communication hub 264 from ports 266, 268 or network interface 262, the data is communicated to the other port 268, 266 or network interface 262. For example, a header of the data is read by the receiving device to determine if the data is addressed to that device. If so, the data is received and processed by that device. If not, in some embodiments, the data is ignored (or discarded) at that device.

In some embodiments, pass-through device 203 further includes an electronic gate 270 is configured between the communication hub 264 and network port 266. In this example, incoming data received at computer port 268 from a computing device that is addressed to the data packet generator 201, can be selectively blocked by the electronic gate 270, while still being received at the network interface 262. Other communications, however, such as communications between computing devices across the network, are allowed to pass through the electronic gate uninterrupted. In some embodiments, pass-through device 203 is a gateway. Other embodiments do not include an electronic gate and do not operate as a gateway.

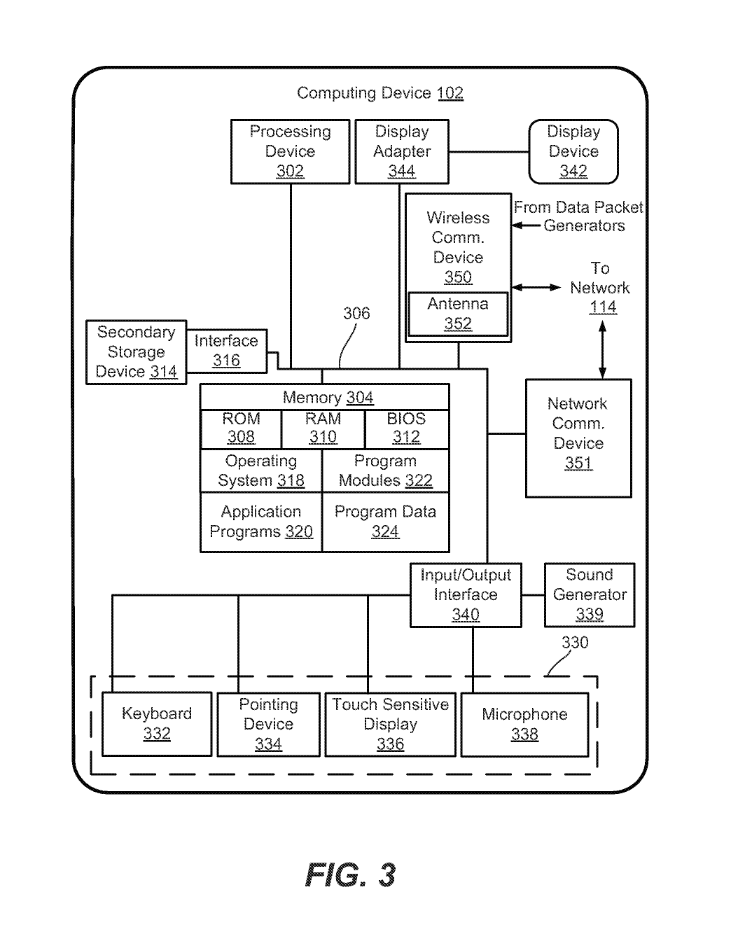

FIG. 3 is a schematic block diagram illustrating an architecture of an example computing device 102 suitable for implementing any one of the various computing devices described herein, including computers or servers.

Computing device 102 includes, in some embodiments, at least one processing device 302 and memory 304. A variety of processing devices 302 are available from a variety of manufacturers, for example, Intel Corporation or Advanced Micro Devices, Inc. In some embodiments, the processing device 302 is configured to perform one or more methods or operations as defined by instructions stored in memory.

Computing device 102 also includes, in some embodiments, at least one memory device 304. Examples of memory 304 include read-only memory 308 and random access memory 310. Basic input/output system 312, containing the basic routines that act to transfer information within computing device 102, such as during start up, is typically stored in read-only memory 308. Memory device 304 can be a part of processing device 302 or can be separate from processing device 302.

In this example, computing device 102 also includes system bus 306 that couples various system components including memory 304 to processing device 302. System bus 306 is one of any number of types of bus structures including a memory bus, or memory controller; a peripheral bus; and a local bus using any of a variety of bus architectures.

In some embodiments, computing device 102 also includes secondary storage device 314 for storing digital data. Examples of secondary storage devices are memory devices or hard disk drives. Secondary storage device 314 is connected to system bus 306 by secondary storage interface 316. Secondary storage devices 314 and their associated computer readable media provide nonvolatile storage of computer readable instructions (including application programs and program modules), data structures, and other data for computing device 102.

In some embodiments, secondary storage device 314 is one of a variety of types of computer readable media. Examples of computer readable media include magnetic cassettes, flash memory cards, digital video disks, Bernoulli cartridges, compact disc read only memories, digital versatile disk read only memories, random access memories, read only memories, hard disc drives, or other memory devices.

A number of program modules can be stored in secondary storage device 314 or memory 304, including operating system 318, one or more application programs 320, other program modules 322, and program data 324. In some embodiments, program modules include data instructions that are stored in computer readable media (such as computer readable storage media). The data instructions, when executed by the processing device 302, cause the processing device 302 to perform one or more of the methods, operations, or functions described herein.

In some embodiments, a user provides inputs to the computing device 102 through one or more input devices 330. Examples of input devices 330 include keyboard 332, pointing device 334 (such as a mouse or trackball), touch sensitive display 336 (or a touchpad), and microphone 338. Other embodiments include other input devices 330. Input devices 330 are often connected to the processing device 302 through input/output interface 340 that is coupled to system bus 306. These input devices 330 can be connected by any number of input/output interfaces, such as a parallel port, serial port, game port, or a universal serial bus. Wireless communication between input devices and interface 340 is possible as well, and includes infrared, BLUETOOTH® wireless technology, 802.11a/b/g/n wireless communication, WiGig, cellular communication, or other radio frequency communication systems in some possible embodiments. Although input devices and other components of computing device 102 are displayed as being parts of the computing device 102, in other embodiments one or more of the components are an external component that interfaces with computing device 102. An example is an external display device 342 or an external wireless communication device 350.

Output devices are included in some embodiments, such as a sound generator 339 (including a speaker, head phones, or the like), for generating sounds that can be heard by the user.

In some embodiments, a display device 342, such as a monitor, liquid crystal display device, projector, or touch screen display device, is also connected to system bus 306 via an interface, such as display adapter 344. In addition to display device 342, the computing device 102 can include or interface with various other devices, such as a printer, a digital camera, a digital camcorder, or other devices.

When used in a local area networking environment or a wide area networking environment (such as the Internet), computing device 102 is typically connected to network 114 through a wireless communication device 350 including antenna 352, or a network communication device 351. An example of a network communication device is a network adapter for wired communication to network 114, such as through an Ethernet port and cable. In another possible embodiment, computing device 102 can be coupled to another computing device, such as through a USB port or other docking station. Other possible embodiments use other communication devices. For example, some embodiments of computing device 102 include a modem for communicating across network 114.

Computing device 102 typically includes at least some form of computer-readable media. Computer readable media include any available media that can be accessed by computing device 102. By way of example, computer-readable media include computer readable storage media and communication media.

Computer readable storage media includes volatile and nonvolatile, removable and non-removable media implemented in any device configured to store information, such as computer readable instructions, data structures, operating systems 318, application programs 320, program modules 322, program data 324, or other data. Memory 304 is an example of computer readable storage media. Computer readable storage media includes, but is not limited to, read-only memory 308, random access memory 310, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by computing device 102. In some embodiments, computer readable storage media includes computer non-transitory media.

Communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, communication media includes wired media such as a wired network or direct-wired connection, and wireless media such as acoustic, radio frequency, infrared, and other wireless media. In some embodiments, communication media is transitory media. Combinations of any of the above are also included within the scope of computer readable media.

Service

In some embodiments, a service application runs as a system service on an end user's computing device 102, without interaction with or visibility to the end user. Normal operation of the service includes seeking data packet generator codes in the physical environment via one of the two available options, such as wireless or via wires. In some embodiments, the polling interval for data packet generator tokens is configured at 15 minutes; however it can be customized by information technology (IT) representatives depending upon business requirements.

In some embodiments, once the data packet generator token is obtained, the service sends logistical update data, such as via Secure Socket Layer (SSL) encryption, through the client's Internet connection to data packet generator server 116. Once data has arrived at the data packet generator server 116 it is authenticated and the client's CAFM system 118 print is updated to reflect occupancy in the physical environment.

Operation

In some embodiments, the systems and methods operate in wired, wireless and/or a mix of those two environments. In a wireless environment, assets are already connected to the network through the standard Wi-Fi Access Point. While connected to the corporate data network, the service applet scans for a transmission from a data packet generator 201 within an SSID. In typical embodiments, computing devices are not asked (or allowed) to join the locked wireless SSID layers as all data packets are transmitted via the very name of the SSID.

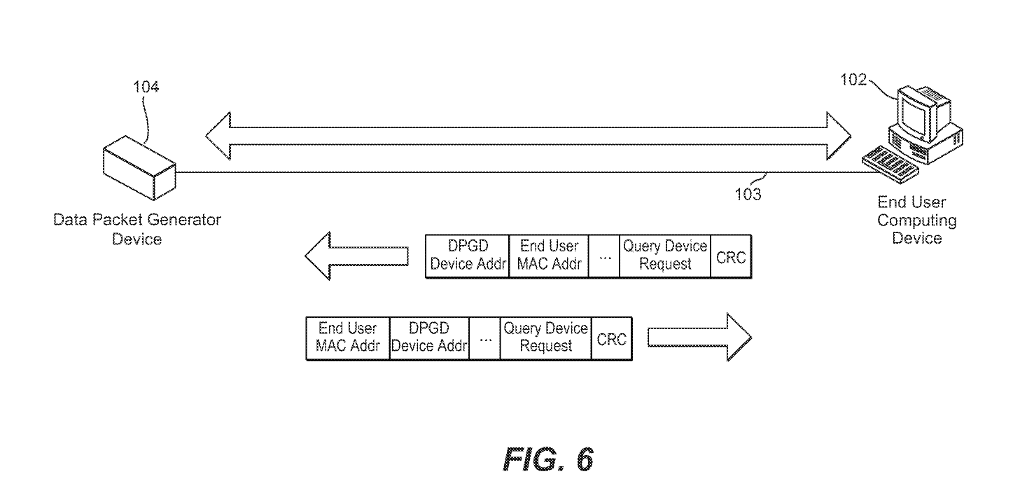

FIG. 6 illustrates exemplary communications between data packet generator device 104 and computing device 102. In some embodiments, Ethernet connected devices use the same software service applet, running on the local PC, but in this case the software sends management frames, coded for data packet generator devices onto the Ethernet. In some embodiments, the data packet generator device 104 utilizes the OSI Data-Link Layer (MAC addressing) to communicate between the computing device 102 and the data packet generator 104. These Ethernet frames request information from a data packet generator device 104 in the path between the end user computing device 102 and the rest of the network. The data packet generator device 104 detects these management frames, and responds appropriately to the end user computing device 102 sending the request.

Network traffic is carried in the Payload/Data section of the Ethernet frame. Data is communicated between the end user computing device and the data packet generator device 104 within the Payload/Data section. In some embodiments the data is formatted according to a predetermined protocol.

IT Value Proposition

Since the service applet is running on every computing asset and the location of those assets is known via the CAFM system 118 print, the system can provide a new layer of automated asset tracking services within buildings. Reducing both lost assets and the important data within them.

IT Impact and Security

Some embodiments are designed to avoid operational and security impacts on a corporate IT network in one or more of the following ways:
1. Communication between computer and the wired data packet generator device does not leave the data packet generator device to enter normal network traffic. When a data packet generator device is not available for communication, the end user service discontinues device queries after a short period of time. At that time, service requests reduce to periodic queries and can report updates to the data packet generator server.
2. Data from the client devices, whether wired or wireless, never enters the data packet generator system.
3. Product firmware is designed to interact directly with hardware (MAC addressing only).
4. The information sent via the client IT network is encrypted and is meaningless without the CAFM location information to interpret.
5. The pass-through adapter has very limited program memory, making it very difficult to add code without compromising normal device operation.
6. Data packet generator data channel attacks are reduced to the link between device and end user and are NOT routable.
7. The pass-through adapter firmware is protected by a security fuse, which inhibits reading out the microcode.
8. To prevent physical tampering, the infra-red gateway between the data packet generator and pass-through adapter are physically keyed. Also, the devices have various tamper sensors.
9. The client device never connects to the data packet generator wireless network. The data packet generator wireless network is a “closed” network and will refuse all connections from external devices.
10. Data packet generator wireless operation can be set for any 802.11 channels and tokens only travel 2-3 meters at the lowest signal strength.

In some embodiments, the systems and methods provide a simple to deploy hardware and software solution to deliver a non-invasive solution for space utilization data and asset tracking. The commercially secure software service collects tokens from data packet generators without ever joining the wireless network of the data packet generator. This provides for minimal impact on operational and security measures on a corporate IT network, making the solution viable for large scale implementations.

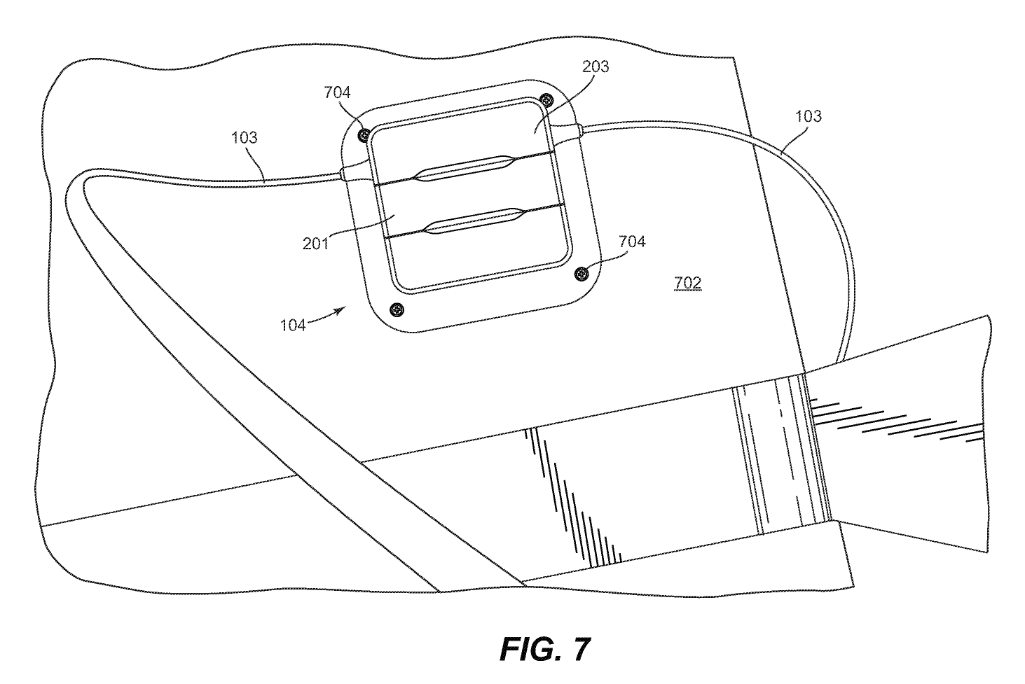

FIG. 7 illustrates a data packet generator device 104 connected to a worksurface 702, such as a lower surface of a desktop. Network cables 103 are connected to the pass-through device 203 of the data packet generator device 104. Data packet generator device 104 is connected to the worksurface 702 by fasteners 704, such as screws.

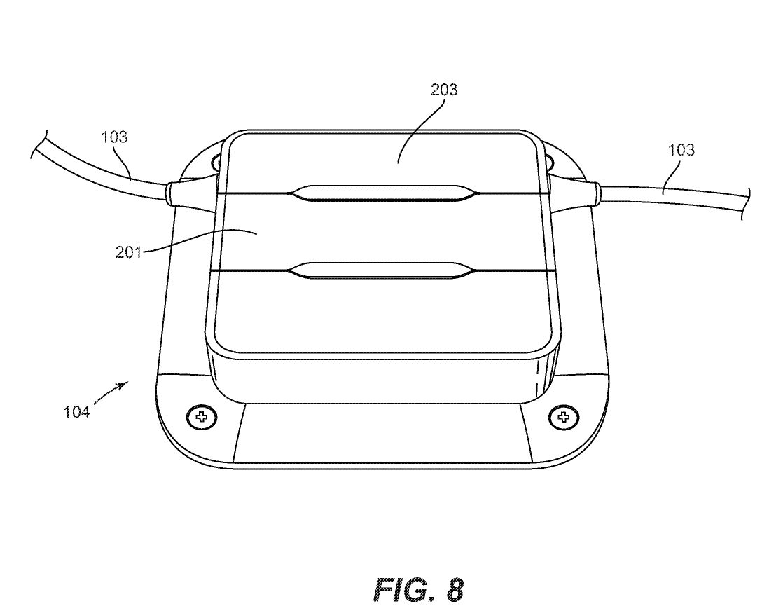

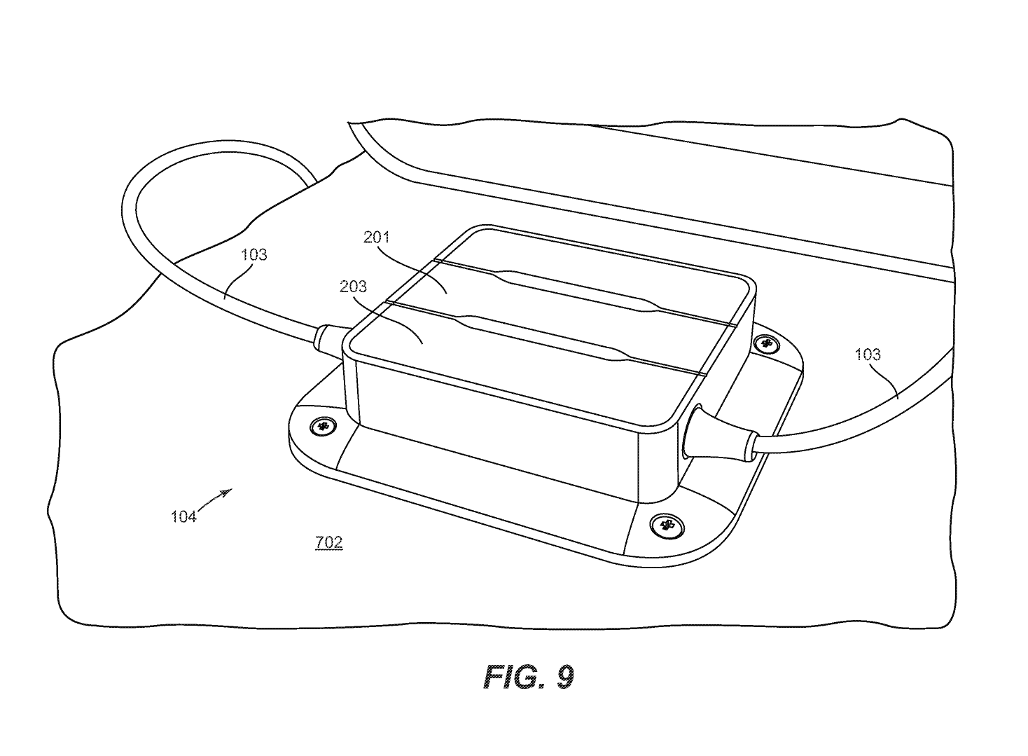

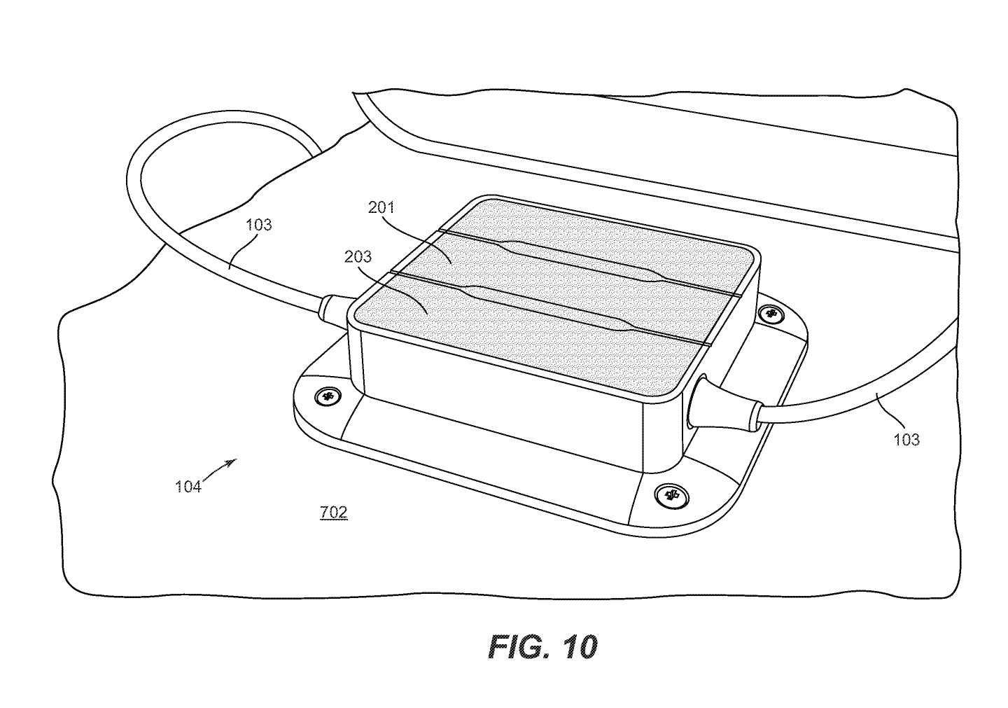

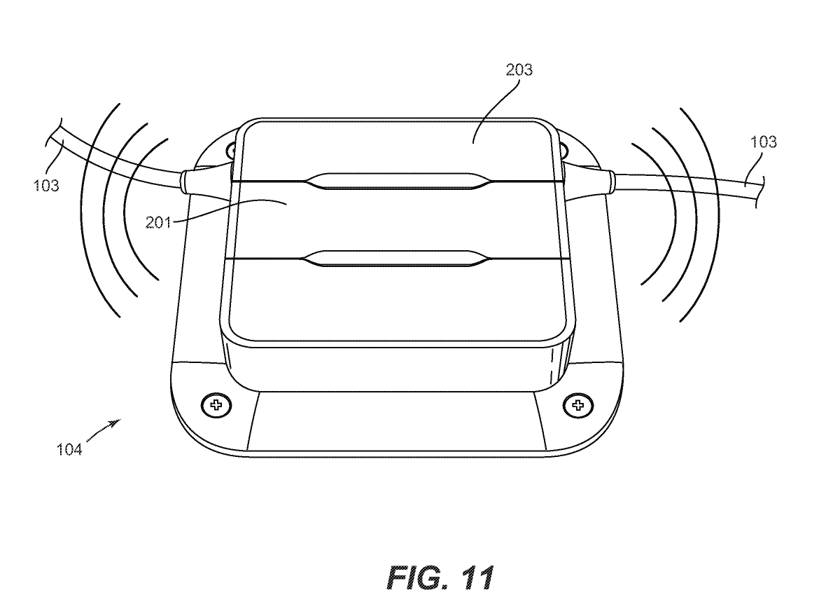

FIGS. 8-12 illustrate additional views, embodiments, and aspects according to the present disclosure. FIG. 8 is a perspective view of an example data packet generator device 104. FIGS. 9-10 are perspective views of example data packet generator devices 104 connected to a worksurface 702. FIG. 11 is a perspective view of a data packet generator 104 during a wireless transmission of a data packet.

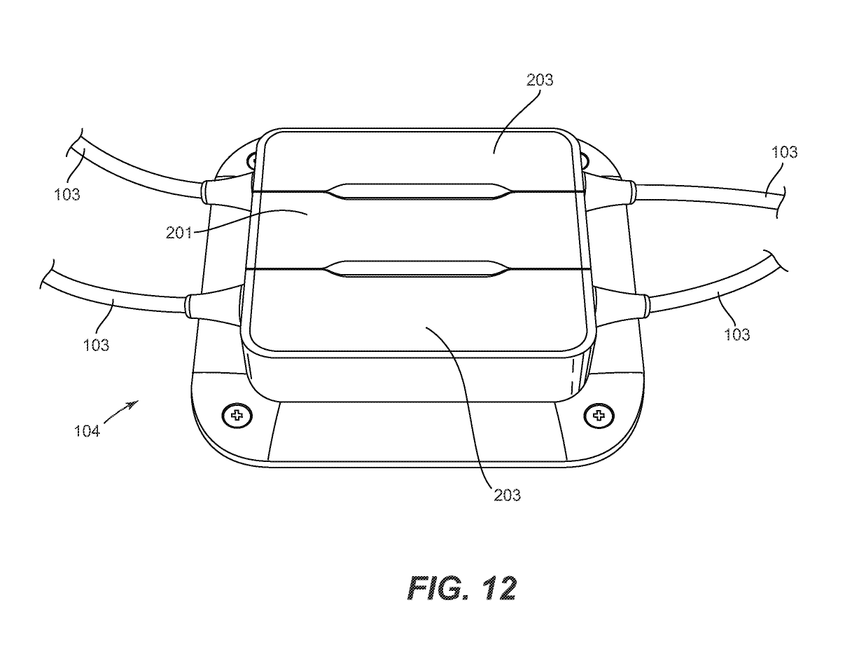

FIG. 12 is a perspective view of a data packet generator device 104, including a data packet generator 201, and two pass-through devices 203. In this embodiment, the data packet generator 201 includes two or more link communication devices 210 (shown in FIG. 2) to communicate with two or more pass-through devices.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A data packet generator device comprising:
at least one processing device that generates a token including a plurality of alphanumeric characters;
a wireless communication device in data communication with the processing device and operable to transmit the token as at least part of a network name; and
a network communication device in data communication with the processing device and operable to communicate the token across a network communication cable.

2. The data packet generator device of claim 1, wherein the data packet generator device further comprises a first link communication device for receiving a token generated by the processing device and communicating the token, and wherein the data packet generator device further comprises a second link communication device for receiving the token and passing the token to the network communication cable.

3. The data packet generator device of claim 1, further comprising a network communication port and a power supply, wherein the power supply receives power from the network communication port.

4. The data packet generator of claim 3, wherein the network communication port is a Power over Ethernet port.

5. The data packet generator device of claim 1, wherein the network communication device includes a network communication hub.

6. The data packet generator device of claim 5, wherein the data packet generator further comprises a network communication port and an electronic gate, wherein the electronic gate selectively blocks data from passing between the communication hub and the network communication port.

7. The data packet generator device of claim 6, wherein the network communication port is a terminal connector physically connected to a network cable.

8. The data packet generator device of claim 1, wherein the network name is a service set identifier (SSID) according to an IEEE 802.11 protocol.

9. The data packet generator device of claim 1, wherein the token includes 32 alphanumeric characters, and wherein the token changes periodically.

10. A data packet generator device comprising:
a data packet generator including a processing device programmed to generate a token;
a pass-through device including at least two network communication ports, and a communication hub, the communication hub including electronics to pass network communications between the at least two network communication ports; and
an isolation link configured to receive the token generated by the processing device and to communicate the token to the pass-through device.

11. The data packet generator device of claim 10, wherein the isolation link comprises first and second link communication devices that communicate using infrared light.

12. The data packet generator device of claim 11, wherein the first link communication device transmits the token and the second link communication device receives the transmission including the token.

13. The data packet generator device of claim 12, wherein the first link communication device is a transmit-only device and the second link communication device is a receive-only device.

14. The data packet generator device of claim 10, wherein the pass-through device further comprises an electronic gate that selectively passes network communication between the at least two network communication ports and blocks communications including the token from passing to at least one of the network communication ports.

15. The data packet generator device of claim 14, wherein the electronic gate is arranged between the communication hub and the one of the network communication ports.

16. The data packet generator device of claim 10, wherein at least one of the network communication ports is a Power over Ethernet port, adapted to receive electricity to power the data packet generator device.

17. The data packet generator device of claim 10, wherein the isolation link comprises at least two isolation links, and further comprising a second pass-through device, wherein a second of the isolation links communicates between the data packet generator and the second pass-through device.

18. An electronic device comprising:
a processing device operable to output a token;
a wireless communication device including an antenna that transmits radio-frequency signals encoding the token;
a network communication port;
a power supply electrically connected to the network communication port to receive power from the network communication port to power the electronic device; and
an isolation link interposed between the processing device and the network communication port.

19. The electronic device of claim 18, wherein the wireless communication device encodes the token as a network name.

20. The electronic device of claim 18, wherein the isolation link generates light.
